(19) United States
(12) Patent Application Publication
(10) Pub. No.: US 2025/0054681 A1
(43) Pub. Date: Feb. 13, 2025

(54) COIL COMPONENT

(71) Applicant: Murata Manufacturing Co., Ltd., Kyoto-fu (JP)

(72) Inventors: Hayato TAKAHASHI, Nagaokakyo-shi (JP); Yuki KANBE, Nagaokakyo-shi (JP); Shingo NAKAMOTO, Nagaokakyo-shi (JP)

(73) Assignee: Murata Manufacturing Co., Ltd., Kyoto-fu (JP)

(21) Appl. No.: 18/767,527

(22) Filed: Jul. 9, 2024

(30) Foreign Application Priority Data
Aug. 10, 2023 (JP) 2023-130613

(51) Int. Cl. H01F 27/28; H01F 27/24; H01F 27/29; H01F 27/30

(52) U.S. Cl. CPC H01F 27/2823; H01F 27/24; H01F 27/292; H01F 27/306

(57) ABSTRACT

A coil component includes a core including a winding core extending in an axial direction and a first flange portion and a second flange portion provided on respective both end portions, in the axial direction, of the winding core; electrodes including a first electrode and a second electrode provided on the first flange portion and the second flange portion, respectively; and a first wire wound around the winding core and including a first end portion joined to the first electrode and a second end portion joined to the second electrode. The first electrode has a first joint surface to which the first end portion is joined, at least one protrusion is provided on the first joint surface, and the first end portion is joined to the first joint surface with the first wire passing over the at least one protrusion provided on the first joint surface.

### CROSS-REFERENCE TO RELATED APPLICATION

This application claims benefit of priority to Japanese Patent Application No. 2023-130613, filed Aug. 10, 2023, the entire content of which is incorporated herein by reference.

### BACKGROUND

### Technical Field

The present disclosure relates to a coil component.

### Background Art

Coil components are used for, for example, filtering radiation noise or the like in various types of electronic devices. Japanese Unexamined Patent Application Publication No. 2007-208227 discloses a configuration of a coil component in which two wires in a pair are wound around a winding core of a ferrite core, and engagement portions that are recesses are provided in the winding core. The paired wires are caught in the engagement portions of the winding core so as to be suppressed from being shifted, and clearance is thus suppressed from being left between the paired wires.

### SUMMARY

However, Japanese Unexamined Patent Application Publication No. 2007-208227 does not disclose, in the coil component, the joining between electrodes provided on both ends of the winding core and the wires. When the wire comes off the electrode, the coil component cannot exhibit the original functions thereof and is thus treated as a defective product. Thus, an improvement in the joint strength between the electrode and the wire has been required.

Accordingly, the present disclosure provides a coil component that can improve the joint strength between an electrode and a wire extending from a winding core.

A coil component according to the present disclosure includes a core including a winding core extending in an axial direction and a first flange portion and a second flange portion provided on respective both end portions, in the axial direction, of the winding core; electrodes including a first electrode and a second electrode provided on the first flange portion and the second flange portion, respectively; and a first wire wound around the winding core and including a first end portion joined to the first electrode and a second end portion joined to the second electrode. The first electrode has a first joint surface to which the first end portion is joined. At least one protrusion is provided on the first joint surface. The first end portion is joined to the first joint surface with the first wire passing over the at least one protrusion provided on the first joint surface.

The protrusion serves as an anchor that holds the first end portion of the first wire to the first joint surface, and the first end portion of the first wire thereby hardly comes off the first electrode. Thus, the joint strength between the first electrode and the first end portion of the first wire can be improved.

According to the disclosure, it is possible to provide the coil component that can improve the joint strength between the electrode and the wire extending from the winding core.

The above-described object, other objects, features, and advantages of the present disclosure will become more apparent from the following description of a preferred embodiment with reference to the drawings.

### BRIEF DESCRIPTION OF THE DRAWINGS

FIG. 1 is an external perspective view of an example of a coil component according to a preferred embodiment of the present disclosure;

FIG. 2 is a bottom view of FIG. 1;

FIG. 3 is a top view of FIG. 1;

FIG. 4 is a side view of FIG. 1;

FIG. 5 is a sectional view taken along line V-V in FIG. 2;

FIGS. 6A and 6B are each a sectional view taken along line VI-VI in FIG. 2, that is, FIG. 6A is a sectional view of an end portion of a wire having a rectangular sectional shape, and FIG. 6B is a sectional view of an end portion of a wire having a sectional shape having different thicknesses depending on portions;

FIG. 7 is an enlarged bottom view of Alternative Aspect 1 of the arrangement position of a protrusion;

FIG. 8 is an enlarged bottom view of Alternative Aspect 2 of the arrangement position of a protrusion;

FIG. 9 is an enlarged bottom view of Alternative Aspect 3 of the arrangement position of a protrusion;

FIGS. 10A and 10B are each a sectional view, corresponding to line V-V in FIG. 2, of Alternative Aspect 1 of the shape of a protrusion, that is, FIG. 10A is a sectional view of the shape of a protrusion in a first winding core-side end portion, and FIG. 10B is a sectional view of the shape of a protrusion in a first winding core-opposite side end portion;

FIG. 11 is an external perspective view of an example of a coil component according to a modified example of the present disclosure;

FIG. 12 is a bottom view of an example of a coil component according to another modified example of the present disclosure; and

FIG. 13 is a sectional view, taken along line V-V in FIG. 2, of a coil component including an electrode for which a coated electrode is used.

### DETAILED DESCRIPTION

### 1. Coil Component

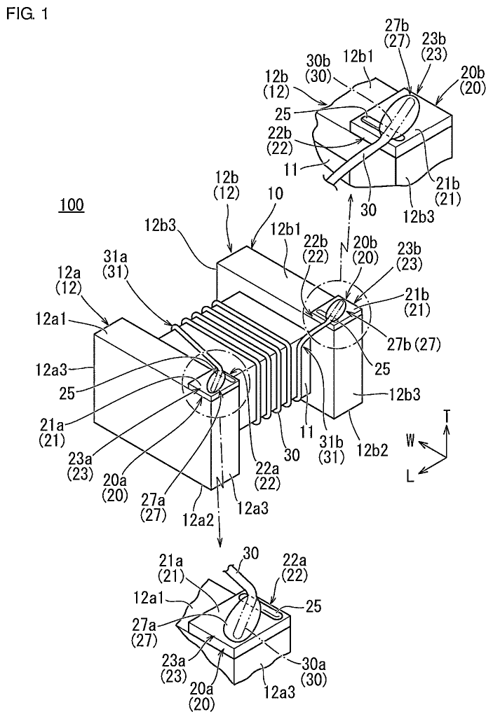

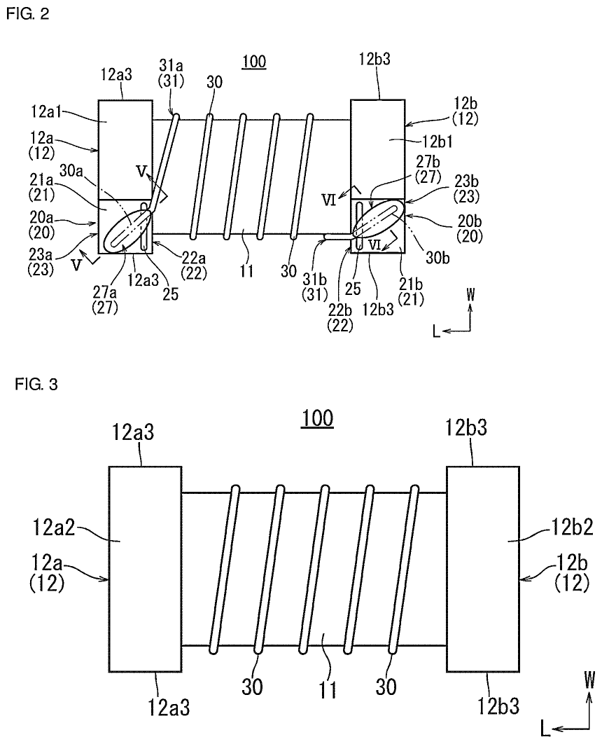

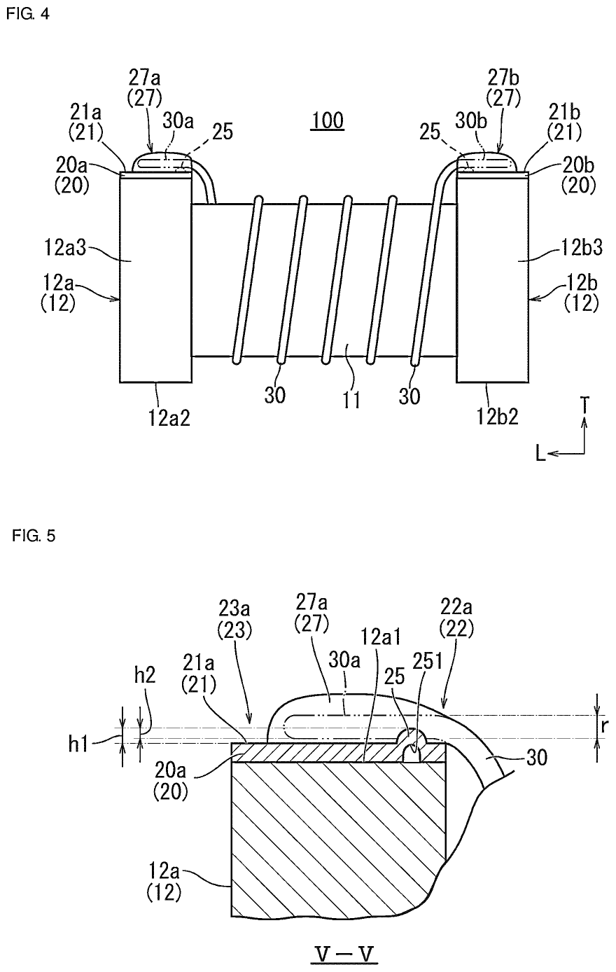

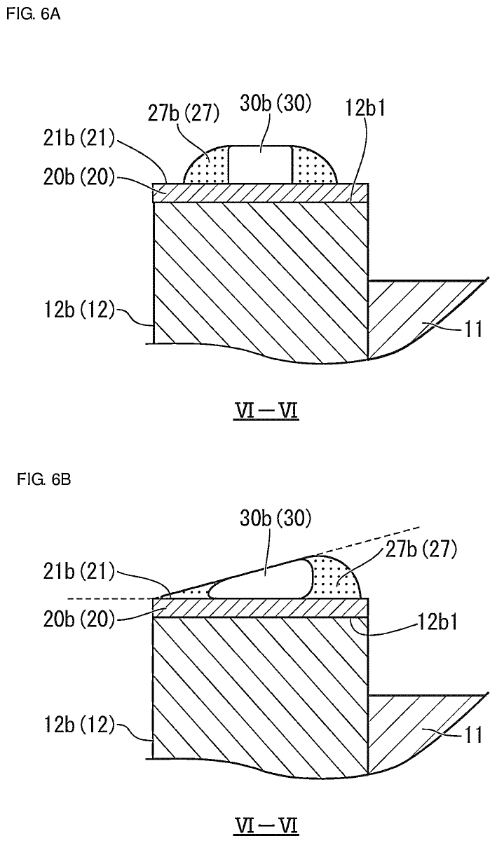

A coil component according to a preferred embodiment of the present disclosure will be described. FIG. 1 is an external perspective view of an example of the coil component according to the preferred embodiment of the present disclosure. FIG. 2 is a bottom view of FIG. 1. FIG. 3 is a top view of FIG. 1. FIG. 4 is a side view of FIG. 1. FIG. 5 is a sectional view taken along line V-V in FIG. 2. Note that FIG. 5 is simplified by deleting a winding core 11 so as to illustrate a first flange portion 12a, a protrusion 25, a first end portion 30a, and other portions. FIGS. 6A and 6B are each a sectional view taken along line VI-VI in FIG. 2, that is, FIG. 6A is a sectional view of an end portion of a wire having a rectangular sectional shape, and FIG. 6B is a sectional view of an end portion of a wire having a sectional shape having different thicknesses depending on portions.

A coil component 100 includes a core 10, electrodes 20, and a wire 30. In the present preferred embodiment, a common mode choke coil will be described as an example of the coil component 100. However, the coil component is not limited to such a common mode choke coil, and examples thereof include winding-type coil components such as a transformer and a coupled inductor. Hereinafter, each part will be described.

The core 10 includes the winding core 11 and a pair of flange portions 12. Here, in FIGS. 1 to 4 and other figures, a direction where the paired flange portions 12 are opposite to each other is an L direction and is also a length direction of the core 10. With the surface, of the flange portion 12 of the core 10, on which the electrode 20 is disposed as a bottom surface, a direction, of the bottom surface directions, orthogonal to the L direction is a W direction and is also a width direction of the core 10. A direction orthogonal to the L direction and the W direction is a T direction and is also a height direction of the core 10.

The winding core 11 extends in the axial direction (here, the L direction). The wire 30 is wound around the winding core 11. The paired flange portions 12 include a first flange portion 12a and a second flange portion 12b that are provided on both end portions, in the axial direction, of the winding core 11. The electrodes 20 to which both end portions of the wire 30 are connected are disposed on the first flange portion 12a and the second flange portion 12b.

The first flange portion 12a and the second flange portion 12b are each formed slightly larger than the winding core 11. The first flange portion 12a is disposed on one of both the end portions of the winding core 11 so as to jut out from the winding core 11 in a direction orthogonal to the axial direction. In the example of FIG. 1 and other figures, the first flange portion 12a has a cuboid shape and has a first bottom surface 12al on which a first electrode 20a, which will be described later, is disposed, a first upper surface 12a2 opposite to the first bottom surface 12a1, and a pair of first side surfaces 12a3 coupling the first bottom surface 12al and the first upper surface 12a2. The first flange portion 12a further has an inner surface facing the winding core 11 side and an outer surface facing away from the winding core 11.

The second flange portion 12b is disposed on the other one of both the end portions of the winding core 11 so as to jut out from the winding core 11 in a direction orthogonal to the axial direction. In the example of FIG. 1 and other figures, the second flange portion 12b has a shape similar to the shape of the first flange portion 12a. The second flange portion 12b has a cuboid shape and has a second bottom surface 12b1 on which a second electrode 20b, which will be described later, is disposed, a second upper surface 12b2 opposite to the second bottom surface 12b1, and a pair of second side surfaces 12b3 coupling the second bottom surface 12b1 and the second upper surface 12b2. The second flange portion 12b further has an inner surface facing the winding core 11 side and an outer surface facing away from the winding core 11.

In the example of FIG. 1 and other figures, the winding core 11 and the paired flange portions 12 each have a cuboid shape. However, the shapes of the winding core 11 and the paired flange portions 12 are not limited thereto, and examples of the shapes may include a circular cylindrical shape, an elliptic cylindrical shape, a cubic shape, and a polygonal columnar shape. The core 10 may be made of a magnetic material, examples of which include ferrite and an amorphous alloy, or may be made of a nonmagnetic material, examples of which include alumina and a resin.

In the present preferred embodiment, the wire 30 is constituted by one piece of wire. Hereinafter, the wire in the example of FIG. 1 is referred to as a first wire 30 (an example of the wire). The first wire 30 is wound around the winding core 11 of the core 10. The first wire 30 is configured by covering a conductive wire made of a conductive material and disposed inside, with a covering material that is an insulating material. Examples of the material for the conductive wire include copper, silver, and gold. The conductive wire has, for example, a thin circular cylindrical shape. However, the conductive wire may have a plate shape having a width. Examples of the material for the covering material include an enamel resin, a polyurethane resin, and a polyamide-imide resin. The first wire 30 includes both end portions. The first end portion 30a, which is one end portion of the first wire 30, is joined to the first electrode 20a. A second end portion 30b, which is the other end portion of the first wire 30, is joined to the second electrode 20b. Note that the number of wires is not limited to one.

The electrodes 20 include the first electrode 20a to which the first end portion 30a is joined and the second electrode 20b to which the second end portion 30b is joined. The first electrode 20a is provided on the first flange portion 12a, and the second electrode 20b is provided on the second flange portion 12b. On the first flange portion 12a, the first electrode 20a may be disposed on one end portion, in the W direction, of the first bottom surface 12a1, may alternatively be disposed on the other end portion, in the W direction, of the first bottom surface 12al, or may be disposed in the vicinity of the center. The first electrode 20a may be disposed so as to cover the entire first bottom surface 12al in the first flange portion 12a. Note that, in the present preferred embodiment, the first electrode 20a is disposed on one end portion, in the W direction, of the first bottom surface 12al in the first flange portion 12a. On the second flange portion 12b, the second electrode 20b may be disposed, on one end portion, in the W direction, of the second bottom surface 12b1, may alternatively be disposed on the other end portion, in the W direction, of the second bottom surface 12b1, or may be disposed in the vicinity of the center. The second electrode 20b may be disposed so as to cover the entire second bottom surface 12b1 in the second flange portion 12b. Note that, in the present preferred embodiment, the second electrode 20b is disposed on one end portion, in the W direction, of the second bottom surface 12b1 in the second flange portion 12b. That is, in the present preferred embodiment, the first electrode 20a and the second electrode 20b are disposed on the same side relative to the winding core 11 in a bottom surface direction.

In the present preferred embodiment, the first and second electrodes 20a and 20b are each constituted by a metal plate. The first and second electrodes 20a and 20b have joint surfaces 21 joined to the first end portion 30a and the second end portion 30b of the first wire 30. Specifically, the first electrode 20a on the first bottom surface 12al has a first joint surface 21a at which the first electrode 20a and the first end portion 30a are joined to each other. The second electrode 20b on the second bottom surface 12b1 has a second joint surface 21b at which the second electrode 20b and the second end portion 30b are joined to each other. In FIG. 1, the first and second joint surfaces 21a and 21b are upper surfaces of the first and second electrodes 20a and 20b with the first and second bottom surfaces 12a1 and 12b1 of the first and second flange portions 12a and 12b facing upward.

The first and second electrodes 20a and 20b are bonded to the first and second bottom surfaces 12a1 and 12b1 with an adhesive such as an epoxy resin, but the bonding therebetween is not limited thereto. The first and second electrodes 20a and 20b are each made of a metal, example of which include Cu, Ag, Au, and Fe, and the joint surface 21 is plated with, for example, Sn plating, Ni plating, or double-layer plating of Sn plating and Ni plating.

The end portions 30a and 30b of the first wire 30 are joined to the electrodes 20 by a process, examples of which include laser welding and thermal pressure bonding. The covering material for each of the end portions 30a and 30b of the first wire 30 is removed during laser welding and thermal pressure bonding, and the electrodes 20 and the conductive wire of the first wire 30 are thermally welded at the end portions 30a and 30b. Alloy layers are formed in a joint portion 27 of the electrode 20 and the conductive wire of the end portion 30a of the first wire 30 and in a joint portion 27 of the electrode 20 and the conductive wire of the end portion 30b of the first wire 30. In each of the alloy layers in the case where, for example, Cu is included in the conductive wire of the first wire 30, and Sn and Ni are included in the electrode 20, Cu in the first wire 30 and Sn and Ni in the electrode 20 undergo interdiffusion between the conductive wire and the electrode 20 due to, for example, laser welding and thermal pressure bonding. Thus, there is formed an alloy layer including Cu and at least one of Sn and Ni. In such an alloy layer, a pore between the first wire 30 and the electrode 20 has disappeared due to the interdiffusion, and different types of metals are mixed together; thus, the joint strength between the end portion of the first wire 30 and the electrode 20 can be relatively increased. The first electrode 20a and the first end portion 30a are joined to each other by using a first joint portion 27a constituted by the alloy layer. The second electrode 20b and the second end portion 30b are joined to each other by using a second joint portion 27b constituted by the alloy layer.

In addition, the joint surface 21 has at least one protrusion 25 protruding from a flat portion of the joint surface 21. Note that the protrusion 25 also has a function as the electrode 20 and is part of the electrode 20. In the joint portion 27 of the electrode 20 and the end portion of the first wire 30, the end portion of the first wire 30 is joined to the joint surface 21, with the first wire 30 passing over at least one protrusion 25 provided on the joint surface 21, that is, for example, with the first wire 30 being caught on the protrusion 25. At this point, the end portion of the first wire 30 is in direct contact with the protrusion 25 or is in contact with the protrusion 25 with the joint portion 27 interposed therebetween. As described above, the end portion of the first wire 30 and the electrode 20 are formed into one alloy layer in the joint portion 27. However, there may be a case where a portion of the end portion of the first wire 30 remains in a form of the conductive wire. Thus, regarding the state where the end portion of the first wire 30 is joined to the joint surface 21 with the first wire 30 passing over the protrusion 25 on the joint surface 21, there may be considered the case where the end portion of the first wire 30 is joined to the joint surface 21 with the alloy layer, which is formed by the end portion of the first wire 30 and the electrode 20, passing over the protrusion 25, the case where the end portion of the first wire 30 is joined to the joint surface 21 with the end portion of the first wire 30 in a form of the conductive wire passing over the protrusion 25, and the case where the end portion of the first wire 30 is joined to the joint surface 21 with both the alloy layer and the end portion of the first wire 30 in a form of the conductive wire passing over the protrusion 25. In the present disclosure, “the end portion of the first wire 30 is joined to the protrusion 25” in any of the above cases.

Specifically, at least one protrusion 25 is formed on at least one of the first joint surface 21a and the second joint surface 21b. In the present preferred embodiment, the protrusion 25 is provided on the first joint surface 21a. In the first joint portion 27a of the first electrode 20a and the first end portion 30a of the first wire 30, the first end portion 30a is joined to the first joint surface 21a with the first wire 30 passing over at least one protrusion 25 provided on the first joint surface 21a. At this point, the first end portion 30a of the first wire 30 is in direct contact with the protrusion 25 or is in contact with the protrusion 25 with the first joint portion 27a interposed therebetween. The protrusion 25 is further provided on the second joint surface 21b. In the second joint portion 27b of the second electrode 20b and the second end portion 30b of the first wire 30, the second end portion 30b is joined to the second joint surface 21b with the first wire 30 passing over at least one protrusion 25 provided on the second joint surface 21b. At this point, the second end portion 30b of the first wire 30 is in direct contact with the protrusion 25 or is in contact with the protrusion 25 with the second joint portion 27b interposed therebetween. Note that the protrusion 25 may be provided on one of the first and second joint surfaces 21a and 21b, and, at one of the first and second joint portions 27a and 27b, one of the first and second end portions 30a and 30b may be joined to one of the first and second joint surfaces 21a and 21b, with the first wire 30 passing over the protrusion 25.

Note that, as FIGS. 4, 5 and other figures illustrate, it is preferable that, in at least one of the first and second joint portions 27a and 27b, the protrusion 25 digs into at least one of the first and second end portions 30a and 30b, and the end portion of the first wire 30 is thus joined to the joint surface 21. The state where the protrusion 25 digs into the first end portion 30a or the second end portion 30b is one of the state where the protrusion 25 digs into the alloy layer, the state where the protrusion 25 digs into the end portion of the first wire 30 in a form of the conductive wire, and the state where the protrusion 25 digs into both the alloy layer and the end portion of the first wire 30 in a form of the conductive wire. Such digging of the protrusion 25 of the electrode 20 into the end portion of the first wire 30 increases the strength of the protrusion 25 as an anchor that holds the first wire 30 to the joint surface 21. Thus, the joint strength between the electrode 20 and the first wire 30 can be further improved.

In the present preferred embodiment, the protrusion 25 is provided on a winding core-side end portion 22 that is an end portion, of the joint surface 21, positioned on the winding core 11 side. The winding core-side end portion 22 lies along the end face of the electrode 20 that is on the winding core 11 side and extends in the W direction. In addition, within the joint surface 21, the protrusion 25 is formed long along the winding core-side end portion 22.

The protrusion 25 is provided along a first winding core-side end portion 22a that is an end portion, on the winding core 11 side, of the first joint surface 21a. The protrusion 25 is also provided along a second winding core-side end portion 22b that is the end portion, on the winding core 11 side, of the second joint surface 21b. Note that, when the protrusion 25 is provided on one of the first and second joint surfaces 21a and 21b, the protrusion 25 may be provided on one of the first winding core-side end portion 22a in the first joint surface 21a and the second winding core-side end portion 22b in the second joint surface 21b.

In addition, the first wire 30 can be configured such that, in the vicinity of the winding end or the winding start, a separated portion 31 separated from the winding core 11 is opposite to the end portion of the first wire 30 across the winding core 11. The protrusion 25 is provided on the joint surface 21 of the electrode 20.

In the present preferred embodiment, as the example of FIG. 1 illustrates, a first separated portion 31a, in the turn of the first wire 30 closest to the first flange portion 12a, separated from the winding core 11 is opposite to the first end portion 30a across the winding core 11. The first wire 30 is separated from the winding core 11 and extends through the air in a noncontact manner, between the first separated portion 31a and the first electrode 20a. Such a noncontact portion is hereinafter referred to as an aerial wiring portion.

In the example of FIG. 1, a second separated portion 31b, in the turn of the first wire 30 closest to the second flange portion 12b, separated from the winding core 11 is positioned on the same side as the second end portion 30b relative to the winding core 11. In the example of FIG. 1, the protrusion 25 is provided on the second joint surface 21b of the second electrode 20b. However, the protrusion 25 is not necessarily provided on the second joint surface 21b. The first wire 30 is separated from the winding core 11 and extends through the air in a noncontact manner, between the second separated portion 31b and the second electrode 20b. Such a noncontact portion is hereinafter referred to as an aerial wiring portion.

Note that the above-described protrusion 25 can be formed in a way in which, for example, a mold having a protruding portion is pressed against the electrode 20 so as to deform the electrode 20 in a manner corresponding to the protruding portion of the mold. In addition, the surface opposite from the protrusion 25 has a recessed portion 251 (FIG. 5) recessed by pressing the electrode 20 with the protruding portion of the mold. Air may be included inside the recessed portion 251, or an adhesive may be filled inside the recessed portion 251. In an alternative forming method, by pressing and recessing, with a mold, a portion of the joint surface 21 other than a portion that is to be the protrusion 25, the portion to be the protrusion 25 relatively protrudes and can be formed into the protrusion 25.

Next, a sectional shape of the end portion of the first wire 30 joined on the joint surface 21 will be described. Although the second end portion 30b of the first wire 30 will be described here, the same applies to the first end portion 30a. FIGS. 6A and 6B each illustrate the VI-VI section in FIG. 2. The sectional shape of the second end portion 30b may be rectangular as FIG. 6A illustrates or may have different thicknesses depending on portions as FIG. 6B illustrates. In addition, there may be the case where the second end portion 30b only has a rectangular sectional shape, the case where the second end portion 30b only has a sectional shape having different thicknesses depending on portions, and the case of mixing the above types of shapes.

In further description about FIG. 6A, the second electrode 20b is provided on the second bottom surface 12b1 of the second flange portion 12b. On the second joint surface 21b of the second electrode 20b, the second end portion 30b of the first wire 30 is joined to the second electrode 20b by using the second joint portion 27b. In the example of FIG. 6A, the sectional shape of the second end portion 30b in the second joint portion 27b is rectangular. Note that the section of the second end portion 30b is described as having a rectangular shape here but may have a square shape.

In the further description about FIG. 6B, unlike FIG. 6A, the sectional shapes on the left side and the right side of the second end portion 30b in the second joint portion 27b are different. In the example of FIG. 6B, the thickness of the second end portion 30b gradually decreases from the winding core 11 toward the opposite side therefrom in the axial direction of the winding core 11.

The protrusion 25 has a height, from the joint surface 21, at which the end portion of the first wire 30 is not cut off even when the protrusion 25 digs into the end portion of the wire 30. For example, the height of the protrusion 25 from the joint surface 21 is preferably not greater than the height of the first wire 30 from the joint surface 21. Alternatively, the height of the protrusion 25 is preferably not greater than the height of the joint portion 27. Referring to FIG. 5, a height h1 of the protrusion 25 (the protruding height from the first joint surface 21a) is preferably one-tenth or more and one-quarter or less of a wire diameter r of the first wire 30 (a diameter r of the conductive wire). Thus, it is possible to suppress breakage such as breaking of the first wire 30 due to excessively deep digging of the protrusion 25 into the first wire 30. In addition, a digging depth h2 by which the protrusion 25 digs into the first wire 30 (a distance of the digging of the protrusion 25 inside the conductive wire from the surface of the conductive wire) is a depth at which the end portion of the first wire 30 is not cut off.

### 2. Actions and Effects

(1) According to the above-described preferred embodiment, the protrusions 25 are provided on the joint surfaces 21 (the first and second joint surface 21a and 21b) at which the electrodes 20 (the first and second electrodes 20a and 20b) and the end portions of the first wire 30 (the first and second end portions 30a and 30b) are joined, and the end portions of the first wire 30 are each joined to the joint surface 21 of the electrode 20 with the first wire 30 passing over the protrusion 25. Thus, the protrusion 25 serves as an anchor that holds the end portion of the first wire 30 to the joint surface 21, and the end portion of the first wire 30 thereby hardly comes off the electrode 20. Thus, the joint strength between the electrode 20 and the end portion of the first wire 30 can be improved. For example, the end portion of the first wire 30 is likely to come off the electrode 20 in the case where the joint surface 21 is flat, and there is thus a little part of the electrode 20 on which the end portion of the first wire 30 is caught. However, with the above-described configuration, the protrusion 25 can improve the joint strength between the electrode 20 and the end portion of the first wire 30.

Here, the first wire 30 is wound around the winding core 11, and tension is generated in the first wire 30 from the end portion thereof toward the winding core 11. The tension varies depending on, for example, the temperature variation or the like of the atmosphere in which the coil component 100 is disposed. When large tension is generated from the end portion of the first wire 30 toward the winding core 11 according to such tension variation, the end portion of the first wire 30 may be separated from the electrode 20. However, the protrusion 25 can hold the end portion of the first wire 30 to the electrode 20 as described above, thereby being able to improve the joint strength between the electrode 20 and the end portion of the first wire 30.

(2) According to the above-described preferred embodiment, the protrusion 25 is provided on the winding core-side end portion 22, of the joint surface 21, closer to the winding core 11 side. Here, the first wire 30 is wound around the winding core 11, and tension is generated in the first wire 30 from the end portion thereof toward the winding core 11. When the end portion of the first wire 30 is pulled toward the winding core 11 as described above, the protrusion 25 on the winding core-side end portion 22 serves as an anchor that holds the first wire 30 to the joint surface 21 efficiently. That is, on the winding core 11 side of the joint surface 21, that is, on the side, of the end portion of the first wire 30 on the joint surface 21, closer to the winding core 11, the protrusion 25 on the winding core-side end portion 22 can receive the tension applied to the end portion of the first wire 30 and directed to the winding core 11 side. In particular, when the first wire 30 is pulled from the joint surface 21 toward a surface of the winding core 11 with the joint surface 21 being at a position higher than the surface of the winding core 11, the tension of the end portion of the first wire 30 acts largely on an edge portion, of the joint surface 21, close to the winding core-side end portion 22. The protrusion 25 on the winding core-side end portion 22 can efficiently receive the tension applied to the end portion of the first wire 30 at the edge portion. Thus, the joint strength between the electrode 20 and the end portion of the first wire 30 can be further improved. In addition, even if the first wire 30 is not extended to a winding core-opposite side end portion 23 opposite to the winding core-side end portion 22, the protrusion 25 on the winding core-side end portion 22 can reliably hold the end portion of the first wire 30 to the joint surface 21.

(3) According to the above-described embodiment, within the joint surface 21, the protrusion 25 is formed long along the winding core-side end portion 22. When the protrusion 25 is formed long as described above, the contact area of the protrusion 25 and the end portion of the first wire 30 can be increased, and the end portion of the first wire 30 can be reliably joined to the joint surface 21 with the first wire 30 passing over the protrusion 25. Thus, the joint strength between the electrode 20 and the end portion of the first wire 30 can be further improved. In addition, the end portion of the first wire 30 can be reliably joined to the joint surface 21 such that the first wire 30 passes over the protrusion 25 even when the joint position of the first wire 30 is shifted.

(4) According to the above-described preferred embodiment, the first separated portion 31a is opposite to the first end portion 30a of the first wire 30 across the winding core 11. When the first separated portion 31a is opposite to the first end portion 30a across the winding core 11 as described above, the aerial wiring portion is long compared with when the first separated portion 31a and the first end portion 30a are on the same side relative to the winding core 11. When the aerial wiring portion is long, the tension from the first end portion 30a toward the winding core 11 tends to be large compared with when the aerial wiring portion is short. Even when the tension is large as described above, because the protrusion 25 is provided on the first electrode 20a opposite to the first separated portion 31a across the winding core 11, the protrusion 25 of the first electrode 20a serves as an anchor that holds the first end portion 30a to the first joint surface 21a. Thus, the joint strength between the first electrode 20a and the first end portion 30a of the first wire 30 can be improved.

Note that, according to the above-described preferred embodiment, the second separated portion 31b and the second end portion 30b of the first wire 30 are positioned on the same side relative to the winding core 11. When the second separated portion 31b and the second end portion 30b are positioned on the same side relative to the winding core 11 as described above, the aerial wiring portion is short compared with when the second separated portion 31b and the second end portion 30b are on the opposite sides across the winding core 11. When the aerial wiring portion is short, the tension from the second end portion 30b toward the winding core 11 tends to be small compared with when the aerial wiring portion is long. Even in this case, the joint strength between the second electrode 20b and the second end portion 30b can be further improved when the protrusion 25 is provided on the second joint surface 21b.

(5) In the above-described preferred embodiment, as FIG. 6B illustrates, in the second end portion 30b (the first end portion 30a), the winding core 11 side has a thickness larger than the opposite side from the winding core 11. Such variation in thickness of the second end portion 30b (the first end portion 30a) depending on positions may be considered to be caused by variations in, for example, the shape of the electrode 20, the inclination of the electrode 20, and the pressing force during joining of the second end portion 30b (the first end portion 30a) to the electrode 20. Due to such variation in thickness, the joint strength of the second end portion 30b (the first end portion 30a) relative to the electrode 20 varies. For example, the thick portion of the second end portion 30b (the first end portion 30a) on the winding core 11 side is a portion to which weak pressing force has been applied, and the joint strength between the second end portion 30b (the first end portion 30a) and the electrode 20 may be weak. Even in this case, when the protrusion 25 is provided particularly on the winding core-side end portion 22, the second end portion 30b (the first end portion 30a) can be joined to the second joint surface 21b (the first joint surface 21a), with the thick portion, on the winding core 11 side of the second end portion 30b (the first end portion 30a), passing over the protrusion 25 on the winding core-side end portion 22. Thus, the joint strength between the second end portion 30b (the first end portion 30a) and the electrode 20 can be improved.

Note that, although the preferred embodiment of the present disclosure has so far been disclosed in the above description, the present disclosure is not limited thereto. That is, various modifications can be made to the above-described preferred embodiment with regard to, for example, the mechanisms, the shapes, the materials, the quantities, the positions, or the arrangements, without departing from the scope of the technical ideas and objects of the present disclosure, and the present disclosure includes the modifications.

### 3. Modified Examples

### 1 About Aspects of Protrusion

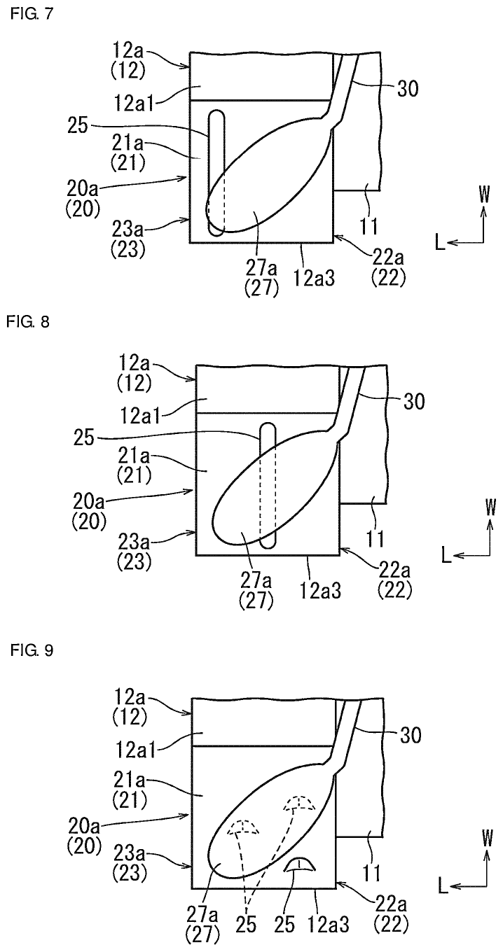

In the above-described preferred embodiment, the protrusion 25 is provided on the winding core-side end portion 22 in the joint surface 21. The position at which the protrusion 25 is arranged is not limited thereto. Alternative aspects of the arrangement position of the protrusion 25 will be described by referring to Alternative Aspects 1 to 3 as examples. FIG. 7 is an enlarged bottom view of Alternative Aspect 1 of the arrangement position of a protrusion. FIG. 8 is an enlarged bottom view of Alternative Aspect 2 of the arrangement position of a protrusion. FIG. 9 is an enlarged bottom view of Alternative Aspect 3 of the arrangement position of a protrusion.

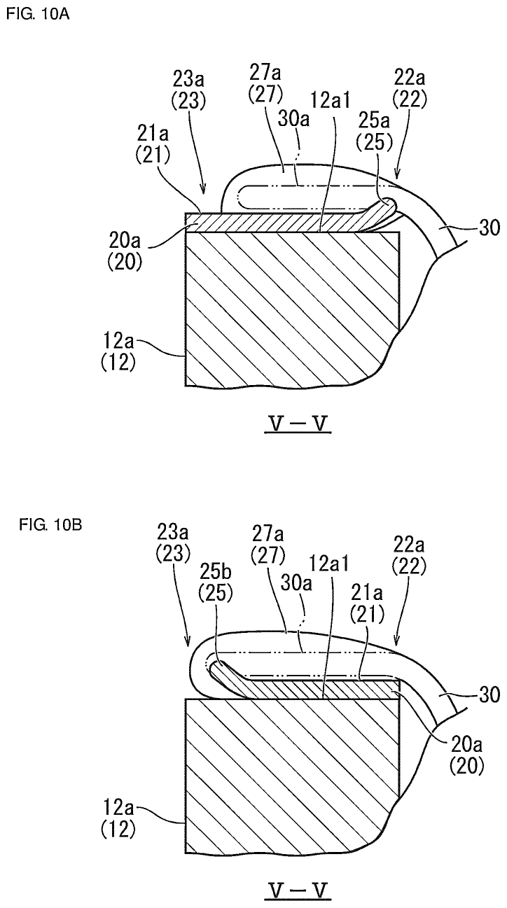

In addition, in the above-described preferred embodiment, the protrusion 25 is formed by causing only a portion of the winding core-side end portion 22 to protrude. The shape of the protrusion 25 is not limited thereto. An alternative shape of the protrusion 25 will be described by referring to Alternative Aspect 1 as an example. FIGS. 10A and 10B are each a sectional view, corresponding to line V-V in FIG. 2, of Alternative Aspect 1 of the shape of a protrusion, that is, FIG. 10A is a sectional view of the shape of a protrusion in the first winding core-side end portion, and FIG. 10B is a sectional view of the shape of a protrusion in the first winding core-opposite side end portion.

### 1-1 Alternative Aspect 1 of Arrangement Position

In FIG. 7, a protrusion 25 is provided on the winding core-opposite side end portion 23 that is the end portion of the joint surface 21 on the opposite side from the winding core 11 side. Specifically, the protrusion 25 is provided on a first winding core-opposite side end portion 23a in the first joint surface 21a. The first winding core-opposite side end portion 23a lies along the end face, of the first electrode 20a, that is on the opposite side from the winding core 11 and extends in the W direction. In addition, within the first joint surface 21a, the protrusion 25 is formed long along the first winding core-opposite side end portion 23a. Similarly, on the second joint surface 21b (refer to FIG. 1), the protrusion 25 can be formed on a second winding core-opposite side end portion 23b (refer to FIG. 1) and formed long along the end face of the second electrode 20b extending in the W direction. The protrusion 25 on the winding core-opposite side end portion 23 also serves as an anchor that holds the end portion of the first wire 30 to the joint surface 21 efficiently. Thus, the joint strength between the electrode 20 and the end portion of the first wire 30 can be further improved. Note that the protrusion 25 can be provided on at least one of the first joint surface 21a and the second joint surface 21b so as to have a long shape on at least one of the winding core-side end portion 22 and the winding core-opposite side end portion 23.

### 1-2 Alternative Aspect 2 of Arrangement Position

In FIG. 8, a protrusion 25 is provided on a center portion, in the joint surface 21, between the winding core-side end portion 22 and the winding core-opposite side end portion 23. Specifically, the protrusion 25 is formed long in the W direction on the center portion of the first joint surface 21a. Similarly, the protrusion 25 can be formed long in the W direction on a center portion of the second joint surface 21b (refer to FIG. 1). Note that the protrusion 25 can be provided on at least one of the first joint surface 21a and the second joint surface 21b so as to have a long shape on at least one of the winding core-side end portion 22, the winding core-opposite side end portion 23, and the center portion.

### 1-3 Alternative Aspect 3 of Arrangement Position

In FIG. 9, a protrusion 25 does not have a shape formed long in the W direction but has a shape protruding in a local manner. In the example of FIG. 9, plural protrusions 25 in a locally protruding shape are formed on multiple places of the first joint surface 21a. Similarly, plural protrusions 25 in a locally protruding shape can be formed on multiple places of the second joint surface 21b. Note that the protrusion 25 may be provided so as to have at least one of the shape formed long on the winding core-side end portion 22, the shape formed long on the winding core-opposite side end portion 23, the shape formed long on the center portion, and the locally protruding shape, and the plural types of the shapes may also be combined. Note that the protrusions 25 having plural shapes protruding in a local manner may be arranged in the W direction on the winding core-side end portion 22, may alternatively be arranged in the W direction on the winding core-opposite side end portion 23, or may be arranged in the W direction on the center portion. In addition, in joining between the electrode 20 and the first wire 30, when the end portion of the first wire 30 is joined to the joint surface 21 with the first wire 30 passing over the protrusion 25, the number of the protrusions 25 in such a locally protruding shape is not limited and may be, for example, one.

### 1-4 Alternative Aspect 1 of Shape

In FIGS. 10A and 10B, although a protrusion 25a of the first electrode 20a will be described, a protrusion 25a of the second electrode 20b can be formed in a similar way. In FIG. 10A, the protrusion 25a is formed by forming the first winding core-side end portion 22a of the first electrode 20a into a curved-up shape. The protrusion 25a rises up off the first bottom surface 12al by being curved up to the side away from the first bottom surface 12al in the T direction (a direction orthogonal to the axial direction), with the first winding core-side end portion 22a being inclined relative to a flat portion other than the first winding core-side end portion 22a. That is, in the first electrode 20a, the first winding core-side end portion 22a, to the side thereof closest to the winding core 11, rises up off the first bottom surface 12a1.

In FIG. 10B, a protrusion 25b is formed by forming the first winding core-opposite side end portion 23a of the first electrode 20a into a curved-up shape. The protrusion 25b rises up off the first bottom surface 12al by being curved up to the side away from the first bottom surface 12al in the T direction, with the first winding core-opposite side end portion 23a being inclined relative to a flat portion other than the first winding core-opposite side end portion 23a. That is, in the first electrode 20a, the first winding core-opposite side end portion 23a, to the side thereof opposite from and farthest from the winding core 11, rises up off the first bottom surface 12a1.

As FIGS. 10A and 10B illustrate, the end portion of the first wire 30 can be further easily caught on each of the curved-up protrusions 25a and 25b that are formed with the winding core-side end portion 22 and the winding core-opposite side end portion 23 being curved up off the bottom surface of the flange portion 12. Thus, the curved-up protrusions 25a and 25b can improve the joint strength between the electrode 20 and the end portion of the first wire 30. Note that the protrusion 25a having a shape formed by curving up the winding core-side end portion 22 can improve the joint strength between the electrode 20 and the end portion of the first wire 30 more than the protrusion 25b. As described above, the tension of the end portion of the first wire 30 acts largely on an edge portion, of the joint surface 21, close to the winding core-side end portion 22. The protrusion 25a corresponds to the edge portion, and the end portion of the first wire 30 can thereby be caught on the protrusion 25a at the portion of the first wire 30 having larger tension; thus, the joint strength can be further easily increased.

As in FIGS. 10A and 10B, in the case where at least one of the winding core-side end portion 22 and the winding core-opposite side end portion 23 of the electrode 20 constituted by a metal plate is formed as a corresponding one of the protrusions 25a and 25b, a protruding portion is provided on an end portion of a mold so as to correspond to the protrusion 25a or the protrusion 25b, when, for example, the electrode 20 constituted by a metal plate is formed. The protrusions 25a and 25b can each be formed by pressing the mold, which has the end portion having the protruding portion, against the metal plate, which is to be the electrode 20, so as to curve up the end portion of the electrode 20. When each of the protrusions 25a and 25b is formed on the corresponding end portion of the electrode 20 as described above, the force generated by the curving up in response to the pressing can be released outward of the mold and the electrode 20; thus, the protrusions 25a and 25b can be formed with relatively small force, without requiring large force, when formed. Thus, the stress applied on the electrode 20 when the protrusions 25a and 25b are formed can be suppressed, and the strength of the electrode 20 can be suppressed from being decreased. In addition, for example, the pressing force between the mold and the electrode 20 can be made relatively small in the case where the protrusion 25a and 25b are formed on the end portions of the joint surface 21, thereby achieving easy forming.

On the other hand, unlike the curved-up protrusions 25a and 25b in FIGS. 10A and 10B, the protrusions 25 in FIG. 1 of the above-described preferred embodiment and in FIGS. 7 to 9 of Alternative Aspects 1 to 3 are each formed so as to protrude partially within the plane of the flat portion of the electrode 20 constituted by a flat metal plate. In the case where such a protrusion 25 is formed, for example, when the electrode 20 constituted by a metal plate is formed, a protruding portion is provided at a desired position partially within a flat surface of the mold so as to correspond to the protrusion 25. By pressing the mold partially having the protruding portion against the metal plate that is to be formed into the electrode 20, a portion of the electrode 20 at a desired position is pressed to protrude into the protrusion 25. When the protrusion 25 is formed partially within the plane of the electrode 20 as described above, the electrode 20 is partially vertically bent to a large extent. Thus, when the protrusion 25 is formed partially within the joint surface 21, the mold is required to be pressed more strongly compared with when the curved-up protrusions 25a and 25b are formed in the end portions of the joint surfaces 21.

### 1-5 Other Aspects

(a) In the above-described preferred embodiment and the aspects in FIGS. 7 and 8, the protrusion 25 is formed long in the W direction. However, as long as the end portion of the first wire 30 is joined to the joint surface 21 of the electrode 20 with the first wire 30 passing over the protrusion 25, the protrusion 25 may be formed long in the L direction.

(b) In the above-described preferred embodiment, in sectional view, the sectional shape of the protrusion 25 has approximate symmetry in the L direction. However, the shape of the protrusion 25 is not limited thereto. For example, in sectional view, the protrusion 25 may protrude while inclining toward the opposite side from the winding core 11 side. That is, the direction where the protrusion 25 protrudes from the joint surface 21 toward the distal end thereof and the direction of the tension generated in the first wire 30 may cross each other. In this case, the end portion of the first wire 30 is easily caught on the protrusion 25 against the tension of the first wire 30 from the winding core 11 side and thus hardly comes off the protrusion 25. Thus, the protrusion 25 serves as an anchor that holds the first wire 30 to the electrode 20 efficiently and can improve the joint strength between the electrode 20 and the end portion the first wire 30.

(c) In addition, in sectional view, the shape of the protrusion 25 is not limited to the tapering shape as in the above-described preferred embodiment. As long as the end portion of the first wire 30 is joined to the joint surface 21 while passing over the protrusion 25, the sectional shape of the protrusion 25 may be a shape such as rectangle or square.

(d) In the above-described preferred embodiment, the protrusion 25 is provided corresponding to the joint surface 21. That is, for example, in FIG. 1, the protrusion 25 is provided on the winding core-side end portion 22 in the joint surface 21. However, the protrusion 25 may be provided at a position corresponding to the end portion of the first wire 30 on the joint surface 21. For example, the protrusion 25 may be provided corresponding to the distal end of the end portion of the first wire 30 on the joint surface 21, or the protrusion 25 may be provided corresponding to the proximal end of the end portion of the first wire 30 on the joint surface 21.

### 2 About Arrangement Position of Electrode

### 2-1 About Arrangement of Electrode on Side Surface of Flange Portion

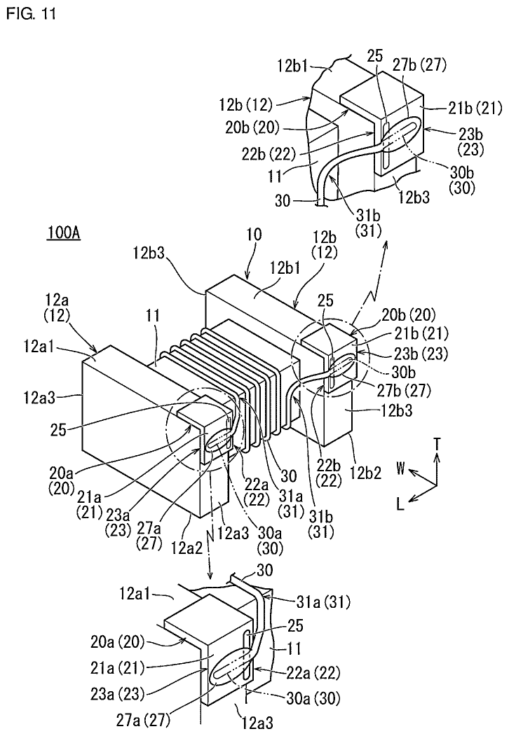

In the above-described preferred embodiment, the first and second electrodes 20a and 20b are arranged on the first bottom surface 12al of the first flange portion 12a and the second bottom surface 12b1 of the second flange portion 12b. However, as long as the first and second end portions 30a and 30b of the first wire 30 and the first and second electrodes 20a and 20b are joined, respectively, the arrangement positions of the first and second electrodes 20a and 20b are not limited thereto. For example, the first and second electrodes 20a and 20b may be arranged on the first side surface 12a3 of the first flange portion 12a and the second side surface 12b3 of the second flange portion 12b. This example will be described below by referring to, as an example, a coil component 100A according to a modified example. FIG. 11 is an external perspective view of an example of the coil component according to the modified example of the present disclosure.

Unlike the coil component 100 of the above-described preferred embodiment, in the coil component 100A according to the modified example, first and second electrodes 20a and 20b are arranged on the first side surface 12a3 and the second side surface 12b3. The first end portion 30a of the first wire 30, while extending toward the first electrode 20a on the first side surface 12a3 side and passing over the protrusion 25, is joined to the first electrode 20a by using a first joint portion 27a. The second end portion 30b of the first wire 30, while extending toward the second electrode 20b on the second side surface 12b3 side and passing over the protrusion 25, is joined to the second electrode 20b by using a second joint portion 27b. Differences from the coil component 100 of the above-described preferred embodiment will be mainly described below.

In the example of FIG. 11, on the first flange portion 12a, the first electrode 20a, while disposed on one end portion, in the W direction, of the first bottom surface 12a1, is bent from the first bottom surface 12al and continuously disposed along the first side surface 12a3. On the second flange portion 12b, the second electrode 20b, while disposed on one end portion, in the W direction, of the second bottom surface 12b1, is bent from the second bottom surface 12b1 and continuously disposed along the second side surface 12b3.

The first electrode 20a on the first side surface 12a3 has a first joint surface 21a at which the first electrode 20a and the first end portion 30a are joined to each other. The second electrode 20b on the second side surface 12b3 has a second joint surface 21b at which the second electrode 20b and the second end portion 30b are joined to each other. In FIG. 11, the first and second joint surfaces 21a and 21b are portions of the first and second electrodes 20a and 20b facing the sides, with the first and second bottom surfaces 12al and 12b1 of the first and second flange portions 12a and 12b facing upward. At this point, the first and second bottom surfaces 12a1 and 12b1 serve as mounting surfaces.

Protrusions 25 are provided on the first and second joint surfaces 21a and 21b and extend along first and second winding core-side end portions 22a and 22b extending along the end faces of the first and second electrodes 20a and 20b extending in the T direction. The first electrode 20a and the first end portion 30a are joined to each other by using the first joint portion 27a constituted by an alloy layer, with the first wire 30 passing over the protrusion 25 on the first joint surface 21a. The second electrode 20b and the second end portion 30b are joined to each other by using the second joint portion 27b constituted by an alloy layer, with the first wire 30 passing over the protrusion 25 on the second joint surface 21b.

In the example of FIG. 11, a first separated portion 31a, in the turn of the first wire 30 closest to the first flange portion 12a, separated from the winding core 11 is positioned on the same side as the first end portion 30a relative to the winding core 11. A second separated portion 31b, in the turn of the first wire 30 closest to the second flange portion 12b, separated from the winding core 11 is positioned on the same side as the second end portion 30b relative to the winding core 11.

Note that, in the example of FIG. 11, the first and second electrodes 20a and 20b are arranged on the first and second side surfaces 12a3 and 12b3 in addition to the first and second bottom surfaces 12al and 12b1. However, the first and second electrodes 20a and 20b may be arranged only on the first and second side surfaces 12a3 and 12b3.

### 2-2 About Arrangement of First and Second Electrodes on the Same Side

In the above-described preferred embodiment, the first and second electrodes 20a and 20b are arranged on the same side relative to the winding core 11. However, according to the performance of the coil component 100, the first and second electrodes 20a and 20b may be arranged diagonally across the winding core 11. For example, the first electrode 20a can be arranged on an end portion on one side, in the W direction, of the first bottom surface 12al in the first flange portion 12a. On the other hand, the second electrode 20b can be disposed on an end portion on the other side, in the W direction, of the second bottom surface 12b1 in the second flange portion 12b.

### 3 About the Number of Wires

In the above-described preferred embodiment, the wire 30 includes only one first wire 30. However, the number of wires is not limited thereto, and two or more wires may be included. The electrodes include plural pairs of electrodes to which both end portions of each wire (one end portion and the other end portion) are joined. At least one protrusion is provided on at least one of the joint surfaces of the electrodes to which the end portions of the wires are joined.

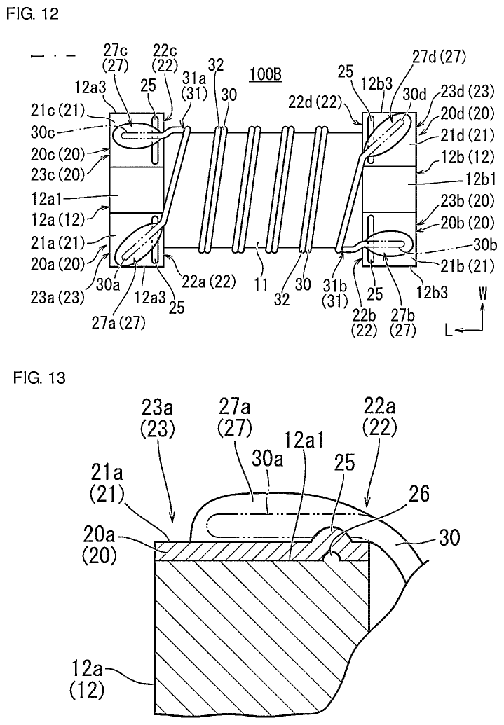

In one example, as for the wire, two wires, that is, the first wire 30 and a second wire 32 may be included. A coil component 100B including the first wire 30 and the second wire 32 will be described below. FIG. 12 is a bottom view of an example of the coil component according to another modified example of the present disclosure. Differences from the coil component 100 according to the preferred embodiment will be mainly described.

The coil component 100B includes the core 10, electrodes 20, the first wire 30, and the second wire 32. The core 10 includes the winding core 11 and one pair of flange portions 12. The first and second wires 30 and 32 are each bifilar-wound around the winding core 11. The first wire 30 includes the first end portion 30a that is one end portion and the second end portion 30b that is the other end portion. The second wire 32 includes a third end portion 30c that is one end portion and a fourth end portion 30d that is the other end portion.

The electrodes 20 include the first electrode 20a, the second electrode 20b, a third electrode 20c, and a fourth electrode 20d. On the first flange portion 12a, the first electrode 20a is opposite to the third electrode 20c across the axial direction that is the center of the winding core 11. The first electrode 20a is provided on one end portion of the first flange portion 12a, and the third electrode 20c is provided on the other end portion of the first flange portion 12a. On the second flange portion 12b, the second electrode 20b is opposite to the fourth electrode 20d across the axial direction that is the center of the winding core 11. The second electrode 20b is provided on one end portion of the second flange portion 12b, and the fourth electrode 20d is provided on the other end portion of the second flange portion 12b.

The first end portion 30a of the first wire 30 is joined to the first electrode 20a. The second end portion 30b of the first wire 30 is joined to the second electrode 20b. The third end portion 30c of the second wire 32 is joined to the third electrode 20c. The fourth end portion 30d of the second wire 32 is joined to the fourth electrode 20d.

The first electrode 20a on the first bottom surface 12al has the first joint surface 21a at which the first electrode 20a and the first end portion 30a are joined to each other. The second electrode 20b on the second bottom surface 12b1 has the second joint surface 21b at which the second electrode 20b and the second end portion 30b are joined to each other. The third electrode 20c on the first bottom surface 12al has a third joint surface 21c at which the third electrode 20c and the third end portion 30c are joined to each other. The fourth electrode 20d on the second bottom surface 12b1 has a fourth joint surface 21d at which the fourth electrode 20d and the fourth end portion 30d are joined to each other.

At least one protrusion 25 is provided on at least one of the first to fourth joint surfaces 21a to 21d. In the example of FIG. 12, the protrusion 25 is formed on the first winding core-side end portion 22a in the first joint surface 21a and protrudes from the first joint surface 21a. The protrusion 25 is formed on the second winding core-side end portion 22b in the second joint surface 21b and protrudes from the second joint surface 21b. The protrusion 25 is formed on a third winding core-side end portion 22c in the third joint surface 21c and protrudes from the third joint surface 21c. The protrusion 25 is formed on a fourth winding core-side end portion 22d in the fourth joint surface 21d and protrudes from the fourth joint surface 21d. In the example of FIG. 12, as with the above-described preferred embodiment, the first to fourth winding core-side end portions 22a to 22d each extend along the end face, of the electrode 20, extending in the W direction. Although not described herein, the protrusion 25 may be provided on at least one of the first to fourth winding core-opposite side end portions 23a to 23d.

The first electrode 20a and the first end portion 30a of the first wire 30 are joined to each other by using the first joint portion 27a constituted by an alloy layer, with the first wire 30 passing over the protrusion 25 provided on the first joint surface 21a. At this point, the first end portion 30a of the first wire 30 is in direct contact with the protrusion 25 or is in contact with the protrusion 25 with the first joint portion 27a interposed therebetween. The second electrode 20b and the second end portion 30b of the first wire 30 are joined to each other by using the second joint portion 27b constituted by an alloy layer, with the first wire 30 passing over the protrusion 25 provided on the second joint surface 21b. At this point, the second end portion 30b of the first wire 30 is in direct contact with the protrusion 25 or is in contact with the protrusion 25 with the second joint portion 27b interposed therebetween. The third electrode 20c and the third end portion 30c of the second wire 32 are joined to each other by using a third joint portion 27c constituted by an alloy layer, with the second wire 32 passing over the protrusion 25 provided on the third joint surface 21c. At this point, the third end portion 30c of the second wire 32 is in direct contact with the protrusion 25 or is in contact with the protrusion 25 with the third joint portion 27c interposed therebetween. The fourth electrode 20d and the fourth end portion 30d of the second wire 32 are joined to each other by using a fourth joint portion 27d constituted by an alloy layer, with the second wire 32 passing over the protrusion 25 provided on the fourth joint surface 21d. At this point, the fourth end portion 30d of the second wire 32 is in direct contact with the protrusion 25 or is in contact with the protrusion 25 with the fourth joint portion 27d interposed therebetween.

With the above-described configuration, even when the number of wires is plural, the protrusion 25 can improve the joint strength between the electrode 20 and the end portion of the wire as with the present preferred embodiment.

### 4 about Coated Electrode Coated with Conductive Metal

In the above-described preferred embodiment, the electrode 20 is a metal terminal electrode into which a metal plate is formed. However, the electrode 20 is not limited thereto, and a coated electrode may also be formed as the electrode 20 by coating the flange portion 12 of the core 10 with a conductive paste including a conductive metal and by firing the coat. FIG. 13 is a sectional view, taken along line V-V in FIG. 2, of a coil component including an electrode for which a coated electrode is used. Note that FIG. 13 is simplified by deleting a winding core 11 so as to illustrate a first flange portion 12a, a protrusion 25, the first end portion 30a, and other portions. Hereinafter, since first and second electrodes 20a and 20b have the same configuration, the first electrode 20a will be described.

The first electrode 20a constituted by a coated electrode illustrated in FIG. 13 is formed so as to have the protrusion 25. Such a first electrode 20a can be formed by providing, on the first flange portion 12a of a core 10, a core protrusion 26 protruding from a first bottom surface 12a1. A mold having, for example, a recessed portion corresponding to the core protrusion 26 is prepared, the material of the core 10 is poured into the mold, the material of the core 10 is pressed with the mold and fired, and the core 10 having the core protrusion 26 on the first bottom surface 12al of the first flange portion 12a is thus formed. In the example of FIG. 13, the core protrusion 26 is formed on the winding core 11 side of the first bottom surface 12a1. When a conductive paste is applied to the first bottom surface 12al having the core protrusion 26, the conductive paste is applied in a way of protruding along the protrusion of the core protrusion 26. The conductive paste is fired to form the first electrode 20a that is the coated electrode having the protrusion 25.

The first electrode 20a, which is the coated electrode, and the first end portion 30a of the first wire 30 are joined to each other by using the first joint portion 27a constituted by an alloy layer, with the first wire 30 passing over the protrusion 25 provided on the first joint surface 21a.

### 5 about Aerial Wiring Portion

In the above-described preferred embodiment, the first separated portion 31a, in the turn of the first wire 30 closest to the first flange portion 12a, separated from the winding core 11 is opposite to the first end portion 30a across the winding core 11. The aerial wiring portion from the first separated portion 31a to the first electrode 20a is relatively long. However, depending on the type of the coil component, the first separated portion 31a and the first end portion 30a may be on the same side relative to the winding core 11, and the aerial wiring portion may be made short.

Note that, when the separated portion 31 that is a portion of the first wire 30 separated from the winding core 11 and the end portion of the first wire 30 are on the same side relative to the winding core 11, the aerial wiring portion is short as described above, and the tension from the end portion of the first wire 30 toward the winding core 11 side is thus small. Even in this case, the joint strength between the electrode 20 and the end portion of the first wire 30 can be further improved when the protrusion 25 is provided on the joint surface 21.

### 6 About Joining of Electrode and Wire

In the above-described preferred embodiment, the electrode 20 and the end portion of the first wire 30 are joined to each other by using the joint portion 27 constituted by an alloy layer, with the first wire 30 passing over the protrusion 25 provided on the joint surface 21. In this case, the alloy layer is formed by a process, examples of which include laser beam welding and thermal pressure bonding. As long as the electrode 20 and the end portion of the first wire 30 are joined to each other, laser beam welding and thermal pressure bonding, for example, are not necessarily employed. The alloy layer is not necessarily formed for the joint portion 27 of the electrode 20 and the end portion of the first wire 30.

For example, the electrode 20 and the end portion of the first wire 30 may be joined to each other by bonding the end portion of the first wire 30 to the electrode 20 with a conductive adhesive with the first wire 30 passing over the protrusion 25 provided on the joint surface 21 of the electrode 20. In addition, for example, the end portion of the first wire 30 may be joined to the electrode 20 by using a conductive material such as solder, with the first wire 30 passing over the protrusion 25 provided on the joint surface 21 of the electrode 20.

<1> A coil component including a core including a winding core extending in an axial direction and a first flange portion and a second flange portion provided on respective both end portions, in the axial direction, of the winding core; electrodes including a first electrode and a second electrode provided on the first flange portion and the second flange portion, respectively; and a first wire wound around the winding core and including a first end portion joined to the first electrode and a second end portion joined to the second electrode. The first electrode has a first joint surface to which the first end portion is joined, at least one protrusion is provided on the first joint surface, and the first end portion is joined to the first joint surface with the first wire passing over the at least one protrusion provided on the first joint surface.

<2> The coil component according to the item <1>, in which the protrusion is provided on or in at least one of a first winding core-side end portion that is an end portion of the first joint surface on the winding core side and a first winding core-opposite side end portion that is an end portion opposite to the first winding core-side end portion and positioned on an opposite side from the winding core side.

<3> The coil component according to the item <2>, in which the protrusion is provided on or in the first winding core-side end portion.

<4> The coil component according to any one of the items <1> to <3>, in which the protrusion digs into the first end portion of the first wire.

<5> The coil component according to any one of the items <1> to <4>, in which the first electrode and the second electrode are metal terminal electrodes constituted by metal plates arranged on at least the first flange portion and the second flange portion, or the first electrode and the second electrode are coated electrodes formed by applying a conductive metal on at least the first flange portion and the second flange portion.

<6> The coil component according to any one of the items <1> to <5>, in which a first separated portion, in a turn of the first wire closest to the first flange portion, separated from the winding core is opposite to the first end portion across the winding core, and the protrusion is provided on the first joint surface of the first electrode.

<7> The coil component according to any one of the items <1> to <6>, further including a second wire including a third end portion and a fourth end portion, in which the electrodes further include a third electrode opposite to the first electrode across the axial direction and provided on the first flange portion and a fourth electrode opposite to the second electrode across the axial direction and provided on the second flange portion. Also, the third end portion is one end portion, of the second wire, joined to the third electrode, the fourth end portion is the other end portion, of the second wire, joined to the fourth electrode, and the third electrode and the fourth electrode have a third joint surface to which the third end portion is joined and a fourth joint surface to which the fourth end portion is joined, respectively. In addition, at least one protrusion is provided on the third joint surface, and the third end portion is joined to the third joint surface with the second wire passing over the at least one protrusion provided on the third joint surface.

<8> The coil component according to any one of the items <1> to <7>, further including a second wire including a third end portion and a fourth end portion, in which the electrodes further include a third electrode opposite to the first electrode across the axial direction and provided on the first flange portion and a fourth electrode opposite to the second electrode across the axial direction and provided on the second flange portion, the third end portion is one end portion, of the second wire, joined to the third electrode, and the fourth end portion is the other end portion, of the second wire, joined to the fourth electrode. Also, the third electrode and the fourth electrode have a third joint surface to which the third end portion is joined and a fourth joint surface to which the fourth end portion is joined, respectively. In addition, at least one protrusion is provided on the fourth joint surface, and the fourth end portion is joined to the fourth joint surface with the second wire passing over the at least one protrusion provided on the fourth joint surface.

<9> The coil component according to any one of the items <1> to <8>, in which the first electrode and the first end portion are joined to each other by using an alloy layer.

<10> The coil component according to the item <9>, in which the alloy layer includes Cu and at least one of Sn and Ni.

<11> The coil component according to any one of the items <1> to <10>, in which the protrusion provided on the first joint surface has a height in a range of one-tenth or more to one-quarter or less of a wire diameter of the first wire.

<12> The coil component according to any one of the items <1> to <11>, in which the protrusion provided in a first winding core-side end portion that is an end portion of the first joint surface on the winding core side is formed to have a shape curved up in a direction where the first winding core-side end portion of the first electrode is away from the first flange portion.

What is claimed is:

1. A coil component comprising:
a core including a winding core extending in an axial direction and a first flange portion and a second flange portion on respective both end portions, in the axial direction, of the winding core;
electrodes including a first electrode and a second electrode on the first flange portion and the second flange portion, respectively; and
a first wire wound around the winding core and including a first end portion joined to the first electrode and a second end portion joined to the second electrode, wherein
the first electrode has a first joint surface to which the first end portion is joined,
at least one protrusion is on the first joint surface, and
the first end portion is joined to the first joint surface with the first wire passing over the at least one protrusion on the first joint surface.

2. The coil component according to claim 1, wherein
the protrusion is on or in
at least one of
a first winding core-side end portion that is an end portion of the first joint surface on the winding core side, and
a first winding core-opposite side end portion that is an end portion opposite to the first winding core-side end portion and on an opposite side from the winding core side.

3. The coil component according to claim 2, wherein
the protrusion is on or in the first winding core-side end portion.

4. The coil component according to claim 1, wherein
the protrusion digs into the first end portion of the first wire.

5. The coil component according to claim 1, wherein
the first electrode and the second electrode are metal terminal electrodes comprising metal plates on at least the first flange portion and the second flange portion, or
the first electrode and the second electrode are coated electrodes including a conductive metal on at least the first flange portion and the second flange portion.

6. The coil component according to claim 1, wherein
a first separated portion, in a turn of the first wire closest to the first flange portion, separated from the winding core is opposite to the first end portion across the winding core, and the protrusion is on the first joint surface of the first electrode.

7. The coil component according to claim 1, further comprising:
a second wire including a third end portion and a fourth end portion, wherein
the electrodes further include a third electrode opposite to the first electrode across the axial direction and on the first flange portion and a fourth electrode opposite to the second electrode across the axial direction and on the second flange portion,
the third end portion is one end portion, of the second wire, joined to the third electrode,
the fourth end portion is the other end portion, of the second wire, joined to the fourth electrode,
the third electrode and the fourth electrode have a third joint surface to which the third end portion is joined and a fourth joint surface to which the fourth end portion is joined, respectively,
at least one protrusion is on the third joint surface, and
the third end portion is joined to the third joint surface with the second wire passing over the at least one protrusion on the third joint surface.

8. The coil component according to claim 1, further comprising:
a second wire including a third end portion and a fourth end portion, wherein
the electrodes further include a third electrode opposite to the first electrode across the axial direction and on the first flange portion and a fourth electrode opposite to the second electrode across the axial direction and on the second flange portion,
the third end portion is one end portion, of the second wire, joined to the third electrode,
the fourth end portion is the other end portion, of the second wire, joined to the fourth electrode,
the third electrode and the fourth electrode have a third joint surface to which the third end portion is joined and a fourth joint surface to which the fourth end portion is joined, respectively,
at least one protrusion is on the fourth joint surface, and
the fourth end portion is joined to the fourth joint surface with the second wire passing over the at least one protrusion on the fourth joint surface.

9. The coil component according to claim 1, wherein
the first electrode and the first end portion are joined to each other by an alloy layer.

10. The coil component according to claim 9, wherein
the alloy layer includes Cu and at least one of Sn and Ni.

11. The coil component according to claim 1, wherein
the protrusion on the first joint surface has a height in a range of one-tenth or more to one-quarter or less of a wire diameter of the first wire.

12. The coil component according to claim 1, wherein
the protrusion in a first winding core-side end portion that is an end portion of the first joint surface on the winding core side has a shape curved up in a direction where the first winding core-side end portion of the first electrode is away from the first flange portion.

13. The coil component according to claim 2, wherein
the protrusion digs into the first end portion of the first wire.

14. The coil component according to claim 2, wherein
the first electrode and the second electrode are metal terminal electrodes comprising metal plates on at least the first flange portion and the second flange portion, or
the first electrode and the second electrode are coated electrodes including a conductive metal on at least the first flange portion and the second flange portion.

15. The coil component according to claim 2, wherein
a first separated portion, in a turn of the first wire closest to the first flange portion, separated from the winding core is opposite to the first end portion across the winding core, and the protrusion is on the first joint surface of the first electrode.

16. The coil component according to claim 2, further comprising:
a second wire including a third end portion and a fourth end portion, wherein
the electrodes further include a third electrode opposite to the first electrode across the axial direction and on the first flange portion and a fourth electrode opposite to the second electrode across the axial direction and on the second flange portion,
the third end portion is one end portion, of the second wire, joined to the third electrode,
the fourth end portion is the other end portion, of the second wire, joined to the fourth electrode,
the third electrode and the fourth electrode have a third joint surface to which the third end portion is joined and a fourth joint surface to which the fourth end portion is joined, respectively,
at least one protrusion is on the third joint surface, and
the third end portion is joined to the third joint surface with the second wire passing over the at least one protrusion on the third joint surface.

17. The coil component according to claim 2, further comprising:
a second wire including a third end portion and a fourth end portion, wherein
the electrodes further include a third electrode opposite to the first electrode across the axial direction and on the first flange portion and a fourth electrode opposite to the second electrode across the axial direction and on the second flange portion,
the third end portion is one end portion, of the second wire, joined to the third electrode,
the fourth end portion is the other end portion, of the second wire, joined to the fourth electrode,
the third electrode and the fourth electrode have a third joint surface to which the third end portion is joined and a fourth joint surface to which the fourth end portion is joined, respectively,
at least one protrusion is on the fourth joint surface, and
the fourth end portion is joined to the fourth joint surface with the second wire passing over the at least one protrusion on the fourth joint surface.

18. The coil component according to claim 2, wherein
the first electrode and the first end portion are joined to each other by an alloy layer.

19. The coil component according to claim 2, wherein
the protrusion on the first joint surface has a height in a range of one-tenth or more to one-quarter or less of a wire diameter of the first wire.

20. The coil component according to claim 2, wherein
the protrusion in a first winding core-side end portion that is an end portion of the first joint surface on the winding core side has a shape curved up in a direction where the first winding core-side end portion of the first electrode is away from the first flange portion.
